(19) United States
(12) Patent Application Publication
(10) Pub. No.: US 2007/0116193 A1
(43) Pub. Date: May 24, 2007

(54) Professional consultant dispatching system

(75) Inventors: Chien-Jen Cheng, Taipei City (TW); Peng-Chi Cheng, Taipei City (TW); Hsiang-Hsin Chang, Taipei City (TW)

Correspondence Address: TROXELL LAW OFFICE PLLC, SUITE 1404, 5205 LEESBURG PIKE, FALLS CHURCH, VA, 22041, US

(73) Assignee: LIFELAW INC.

(21) Appl. No.: 11/258,235

(22) Filed: Oct. 26, 2005

(51) Int. Cl. G06F 17/30; H04M 1/64

(52) U.S. Cl. 379/67.1; 707/5

(57) ABSTRACT

A professional consultant dispatching system is provided, with the following operational steps: (1) a user using communication device to enter interactive voice response system (IVR), (2) the IVR guiding the user to use the communication device to input the criteria for the professional and transmitting the criteria information to a database, (3) the database filtering the data according to the input criteria, (4) a computing module of the database computing the registered professionals and find the matching professionals according to the input criteria, and (5) the database sending the information of the matching professional to the IVR, and the IVR sending service request via the communication device to the matching professional. Through the aforementioned steps, a professional consultant dispatching system that is low in manpower cost, fully utilizing the fragmented time of the professionals, high in service efficiency and low in service cost. The dispatching system overcomes the time and the geographic constrains for professional consultancy providers.

### FIELD OF THE INVENTION

The present invention relates to a professional consultant dispatching system, and, more particularly, to dispatching system for providing consultancy from professional experts, such as accounting, business administration, financial management, legal or other similar professional expertise.

### BACKGROUND OF THE INVENTION

The top of experts in every line of work usually possess knowledge and professional expertise that are key to solve problems. However, most of the knowledge is not easily accessible to the public. For example, many individuals or companies may face various legal situations that require legal assistance or advice. As the fee of a lawyer is usually prohibitively high or the availability information of legal assistance is not easily obtainable, many people that require legal advice either choose to ask amateur individuals with a little legal knowledge for advice or entirely neglect the legal aspect of the problem. This usually leads to the problem running out of control, which requires even more time or money to solve the problem. Furthermore, there could be secondary damages from a fraud lawyer during the seeking of legal advice. All these potential damages are common problems face by individuals or companies when seeking for professional consultancy or advice.

In addition, the need for legal services can be categorized as explicit customers and implicit customers. The explicit customers are those whose needs and contact information is in the market and ready for services, while the implicit customers are those whose needs and contact information is not available in the market and, therefore, is not read for the service. Because the legal service is an industry that is non-transparent and asymmetric in information, the customers usually do not have sufficient channels to obtain the information on the feature, specialty and rate of the lawyers due to the lack of information collections in the conventional venue. Also, as the general public usually has the impression that the lawyers usually charge high for legal services, it is hard to compare the service charge. As a result, most implicit customers choose to seek legal service and stay implicit. On the other hand, the lawyers find it hard to find and convert the implicit customers into explicit customers to expand their customer base.

Although the Internet greatly improves the situation and more free legal advice is readily available through the Internet, some implicit customers have been converted into explicit customers. However, due to the time and geographical constrain and the limited availability of free legal services, there is still a large implicit market base for exploitation. On the other hand, because the way the lawyers work, the work time for a lawyer is usually fragmented and much of their valuable service time is wasted.

However, when an individual or a company faces legal problem, the individual or the company usually wishes to find information on the problem at hand. After obtaining the information, the individual or the company will decide whether to pursue legal actions. But, as the individual or the company is uncertain of the reliability of the information or its source, not to mention the sufficient legal knowledge to decide whether further actions should be taken, the imbalance between the demand and the supply remains in the legal service industry. Therefore, it is imperative for the lawyer to provide consultancy service as the starting point of customer service.

It is, therefore, important to provide a professional consultant dispatching system that is low in cost and high in efficiency to fully utilize the fragmented time of the legal experts to meet the implicit needs. The dispatching system overcomes the time and geographic constrain and creates a win-win situation for both service users and service providers.

### SUMMARY OF THE INVENTION

The primary object of the present invention is to provide a professional consultant dispatching system that is low in manpower cost, fully utilizing fragmented time of the professionals, and high in the service efficiency.

Another object of the present invention is to provide a professional consultant dispatching system that is not constrained by the time and geographical location when consulting professionals.

Yet another object of the present invention is to provide a professional consultant dispatching system that saves the time and fee for both the service users and the service providers.

To achieve the above objects, the present invention provides a professional consultant dispatching system with the following operational steps: (1) a user using communication device to enter interactive voice response system (IVR), (2) the IVR guiding the user to use the communication device to input the criteria for the professional and transmitting the criteria information to a database, (3) the database filtering the data according to the input criteria, (4) a computing module of the database computing the registered professionals and find the matching professionals according to the input criteria, and (5) the database sending the information of the matching professional to the IVR, and the IVR sending service request via the communication device to the matching professional. Through the aforementioned steps, a professional consultant dispatching system that is low in manpower cost, fully utilizing the fragmented time of the professionals, high in service efficiency and low in service cost. The dispatching system overcomes the time and the geographic constrains for professional consultancy providers.

These and other objects, features, and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a block diagram of the structure of the present invention;

FIG. 2 is an operation flowchart of the present invention;

FIG. 3 is an operation flowchart of the computer selection of the present invention;

FIG. 4 shows an operation flowchart when the professional is unavailable for responding the request; and

FIG. 5 is an operation flowchart of customer services of the present invention.

### DETAILED DESCRIPTION OF THE INVENTION

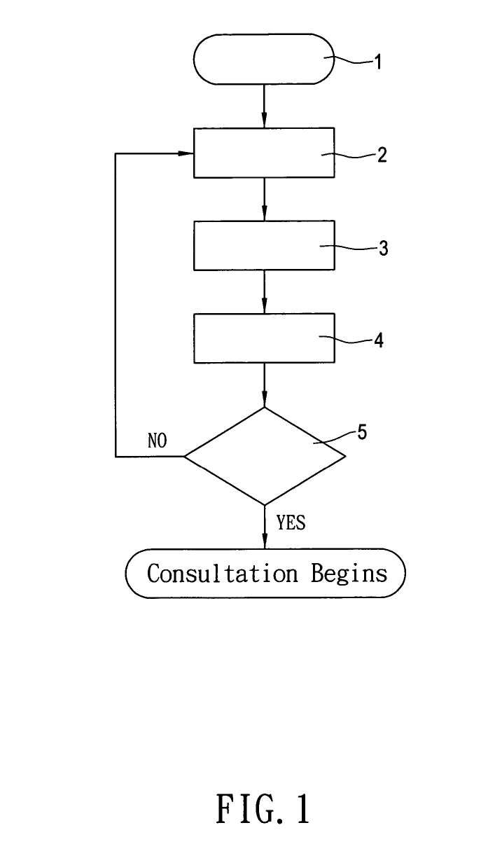

With reference to the drawings and in particular to FIG. 1, a block diagram of the structure of the present invention is shown, including the steps of:

(1) a user using communication device to enter interactive voice response system (IVR);

(2) the IVR guiding the user to use the communication device to input the criteria for the professional and transmitting the criteria information to a database;

(3) the database filtering the data according to the input criteria;

(4) a computing module of the database performing parametric computing on the registered professionals matching the input criteria, and determining a matching professional; and

(5) the database sending the information of the matching professional to the IVR, and the IVR sending service request via the communication device to the matching professional.

Through the aforementioned steps, a professional consultant dispatching system that is low in manpower cost, fully utilizing the fragmented time of the professionals, high in service efficiency and low in service cost. The dispatching system overcomes the time and the geographic constrains for professional consultancy providers.

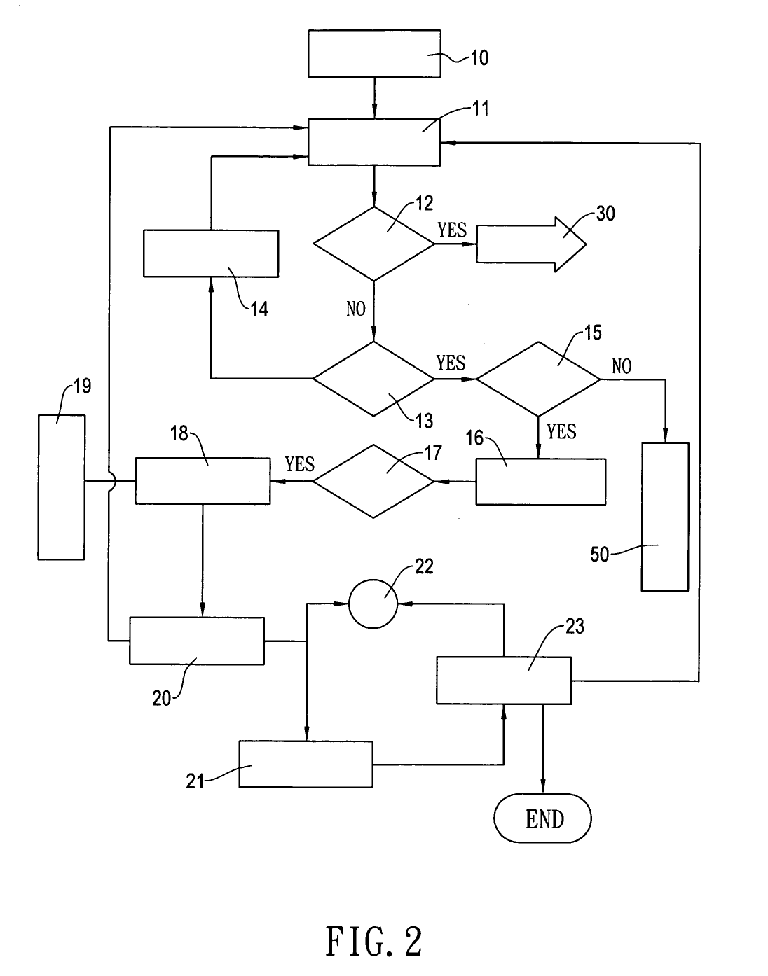

Also referring to FIG. 2, an embodiment using lawyers as an example for the professional will be discussed.

Step 10: the user uses a communication device to enter the IVR, the communication device being a land phone, cell phone or Internet phone.

Step 11: input the code for a lawyer or press # for audio guidance.

Step 12: determine whether # is pressed; if so, enter step 30 for computer selection; otherwise, enter step 13 for inputting lawyer code.

Step 13: input the lawyer code.

Step 14: lawyer code is erroneous, input again or return to step 11.

Step 15: confirm the lawyer code and the availability; if so, enter step 16 for the system to contact the lawyer and wait; otherwise, enter step 50.

Step 16: System contacts the lawyer and wait for the response.

Step 17: If no response, enter step 50; otherwise, enter step 18 for consulting with the lawyer.

Step 18: consult the lawyer.

Step 19: the system updates the state of the lawyer code to “engaged” state.

Step 20: after consulting the lawyer, press (1) for returning to step 11 to consult another lawyer, press (2) to enter step 21 for evaluating the lawyer, press (3) to enter step 22 for customer service, or hang up for exiting the system.

Step 21: Evaluate the lawyer between 1 to 5 points, with 5 being the highest.

Step 22: Connect to customer service.

Step 23: Press (1) for returning to step 11 to consult another lawyer, and press (2) to enter step 22 for customer service.

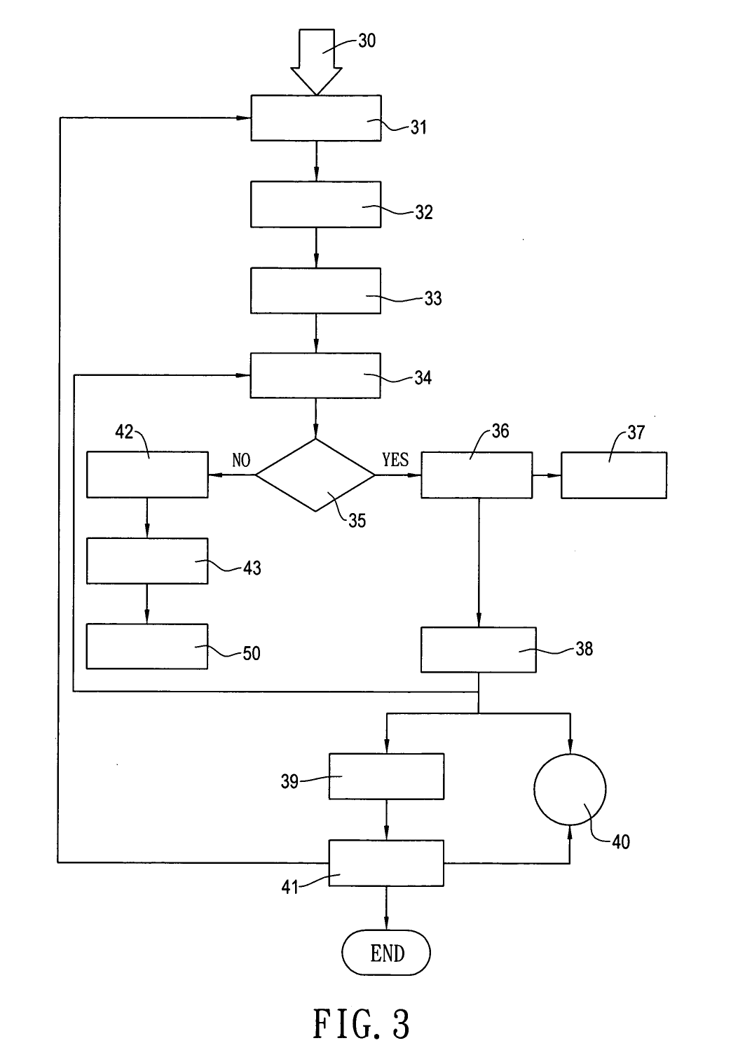

Also referring to FIG. 3, a flowchart of the computer selection (step 30) is shown.

Step 31: Select the consultancy category. Press (1) for life legal problem, press (2) for corporate legal problem, and so on.

Step 32: Select the location of a lawyer. Skip this step by press # or enter a number indicating the location, for example, press (1) for Taipei.

Step 33: the system searches the lawyer record matching the input data.

Step 34: the system is contacting the lawyer, please hold.

Step 35: test whether a connection is made?

Step 36: Connection is made, and the user consults the lawyer.

Step 37: the system updates the state information for the lawyer as “engaged”.

Step 38: after consulting the lawyer, press (1) for returning to step 11 to consult another lawyer, press (2) to enter step 39 for evaluating the lawyer, press (3) to enter step 40 for customer service, or hang up for exiting the system.

Step 39: Evaluate the lawyer between 1 to 5 points, with 5 being the highest.

Step 40: Connect to customer service.

Step 41: Press (1) for returning to step 11 to consult another lawyer, and press (2) to enter step 40 for customer service.

Step 42: no connection to the lawyer is made, the system contacts the next matching lawyer.

Step 43: when all the matching lawyers are not available, enter step 50.

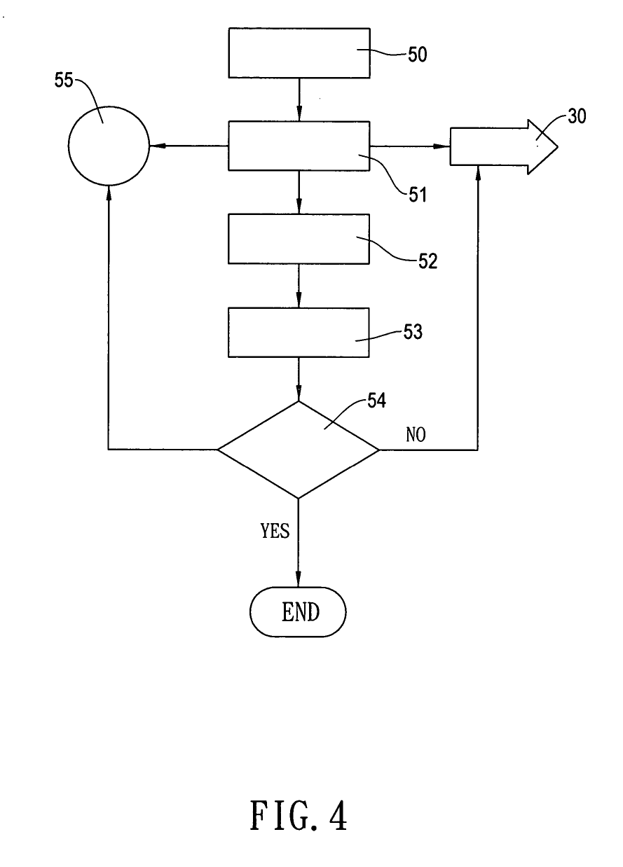

FIG. 4 shows the flowchart of step 50 when a lawyer is unavailable for the consultancy.

Step 51: the selected lawyer is not on-line or is engaged in another consulting session. The user can either leave a message for the lawyer to return the call or the system will select another lawyer. For leaving a message, press (1). For selecting another lawyer, press (2) to enter step 30 of FIG. 3. For customer service, press (3).

Step 52: Listen to the greeting message recorded by the selected lawyer.

Step 53: Leave the message.

Step 54: Press (1) for consulting with another lawyer, press (2) for customer service, or hang up for exiting the system.

Step 55: Connect to customer service.

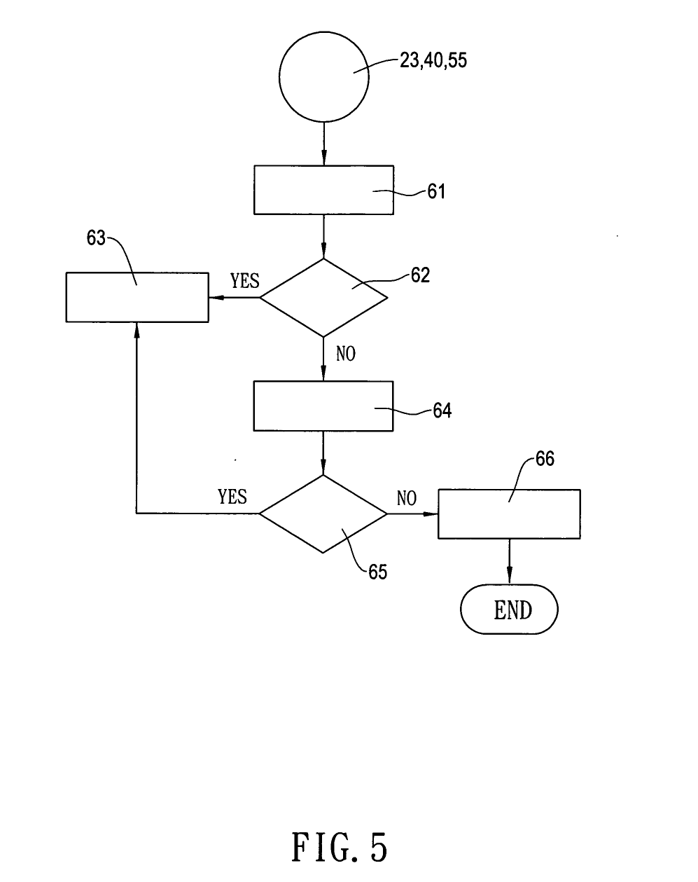

FIG. 5 shows the flowchart of the customer service (step 23, step 40 and step 55) of the system.

Step 61: the system is connecting to the customer service, please hold.

Step 62: check to determine whether a connection is made.

Step 63: a connection is made, and the user talks to the customer service personnel.

Step 64: no connection to the customer service is made. All the personnel are busy, please hold.

Step 65: The waiting exceeds the pre-set limit, and the system redials for connection. If connected, enter step 63.

Step 66: if not, please hang up and dial later.

In summary, the dispatching system of the present invention has the following advantages:

(1) Mobile services: Through the communication device to connect with the interactive voice response system, different users and different lawyers can communicate with each other within the range covered by the communication device's base station, or within the reachable area of the communication network. The mobile consulting service is without the time and geographical constrains.

(2) High service efficiency: The lawyer can decide when to login the system to provide consulting service when utilizing their fragmented time.

(3) Automatic matching: The system automatically searches the available lawyers to improve the service efficiency, reduce manpower and service costs. It also avoids the pressure resulted from lobbying or social connection.

(4) Equal opportunity: The user only needs to remember simple code to access a specific lawyer. The user can also select, through the system, the lawyer to find a suitable lawyer with less time. In addition, all the participating lawyers have equal opportunity to provide consulting services based on their expertise and qualifications.

(5) Easy for future improvement: Through the use of database analysis and customer service tracking, the system helps the lawyers to understand their services and customers for future improvement of services.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A professional consultant dispatching system, comprising the following steps of:
(1) a user using communication device to enter an interactive voice response system (IVR);
(2) the IVR guiding the user to use the communication device to input the criteria for a professional and transmitting the criteria information to a database;
(3) the database filtering the data according to the input criteria;
(4) a computing module of the database performing parametric computing on the registered professionals matching the input criteria, and determining a matching professional; and
(5) the database sending the information of the matching professional to the IVR, and the IVR sending service request via the communication device to the matching professional.

2. The system as claimed in claim 1, wherein the communication device is a land phone, a cell phone, or an Internet phone.

3. The system as claimed in claim 1, wherein the step of the IVR system guiding the user to select a professional is for the user to enter a code for a professional or for a computer to select a professional.

4. The system as claimed in claim 3, wherein the computer selection comprises the following steps of:
(a) selecting a consulting category;
(b) selecting a location of the professional;
(c) the system searching for professionals matching the criteria;
(d) the system informing the professional by connecting the professional for consultancy; and
(e) if no connected, the system dialing the next matching professional or entering customer service for assistance.

5. The system as claimed in claim 4, wherein the step for the professional not being available for connection comprises the following steps of:
(i) the system playing a recorded greeting message by the professional;
(ii) the user leaving a message; and
(iii) searching for another professional or connecting to customer service.
